(19) United States
(12) Patent Application Publication
(10) Pub. No.: US 2013/0050147 A1
(43) Pub. Date: Feb. 28, 2013

(54) TOUCH SENSING DEVICE

(71) Applicants: Hsin-Rong Tseng, Tainan City (TW); Ting-Kuo Chang, Hsinchu City (TW); Chin-Shan Chen, Kaohsiung City (TW)

(72) Inventors: Hsin-Rong Tseng, Tainan City (TW); Ting-Kuo Chang, Hsinchu City (TW); Chin-Shan Chen, Kaohsiung City (TW)

(73) Assignee: AU OPTRONICS CORPORATION, Hsinchu (TW)

(21) Appl. No.: 13/400,584

(22) Filed: Feb. 21, 2012

(30) Foreign Application Priority Data
Aug. 25, 2011 (TW) 100130537

(51) Int. Cl. G06F 3/042

(52) U.S. Cl. 345/175; 178/18.09

(57) ABSTRACT

A touch sensing device includes a substrate, first and second bottom electrodes that are electrically insulated, an active layer, and first and second top electrodes. The substrate has a touch sensing region where the first bottom electrode is located and a non-touch sensing region where the second bottom electrode is located. The active layer on the substrate extends from the touch sensing region to the non-touch sensing region. The first top electrode is on the active layer and above the first bottom electrode. The second top electrode is on the active layer and above the second bottom electrode. A first portion of the active layer in the touch sensing region, the first top electrode, and the first bottom electrode constitute an optical touch sensing unit. A second portion of the active layer in the non-touch sensing region, the second top electrode, and the second bottom electrode constitute a solar cell.

### CROSS-REFERENCE TO RELATED APPLICATION

This application claims the priority benefit of Taiwan application serial no. 100130537, filed on Aug. 25, 2011. The entirety of the above-mentioned patent application is hereby incorporated by reference herein and made a part of this specification.

### BACKGROUND OF THE INVENTION

1. Field of the Invention

The invention relates to a touch sensing device. More particularly, the invention relates to a touch sensing device that includes an optical touch sensing unit and a solar cell.

2. Description of Related Art

Solar energy is a clean, pollution-free, and inexhaustible energy. Since the issue regarding pollution and supply shortage of the petrochemical energy resource is to be resolved, solar energy frequently draws attention. Besides, solar cells have become an important research topic in the industry because solar energy can be directly converted into electric power by the solar cells.

The solar cells have been gradually applied in buildings and electronic products, such as keyboards, mobile phones, notebook computers, and so on. Compared with the solar cells fixed to the buildings, the solar cells applied to the electronic products are often configured on the outer surfaces of the electronic products. In order not to destroy the design of the electronic products nor affect the operation of the electronic products, the area occupied by the solar cells (i.e., the light-receiving area) is not sufficient. As a result, when there is insufficient electric power input from by the solar cells, the solar cells can merely serve as the secondary power source rather than the primary power source.

To expand the light-receiving area of the solar cell, it has been proposed to place a touch sensing panel on the solar cell. Since the touch sensing panel can barely block external light, the solar cell can have sufficient light-receiving area. When the touch sensing panel is placed on the solar cell, an alignment process, an adhesion process, and an assembly process need be further performed, thus resulting in the increasing costs. Accordingly, how to integrate the manufacture of the solar cell and the touch sensing panel in an effective manner is one of the most important research topics.

### SUMMARY OF THE INVENTION

The invention is directed to a touch sensing device in which an optical touch sensing unit and a solar cell share an active layer.

In an embodiment of the invention, a touch sensing device that includes a substrate, a first bottom electrode, a second bottom electrode, an active layer, a first top electrode, and a second top electrode is provided. The substrate has a touch sensing region where the first bottom electrode is located and a non-touch sensing region where the second bottom electrode is located. The first and second bottom electrodes electrically insulated. The active layer is located on the substrate and extends from the touch sensing region to the non-touch sensing region. The first top electrode is located on the active layer and above the first bottom electrode. The second top electrode is located on the active layer and above the second bottom electrode. A portion of the active layer located in the touch sensing region, the first top electrode, and the first bottom electrode constitute an optical touch sensing unit. A portion of the active layer located in the non-touch sensing region, the second top electrode, and the second bottom electrode constitute a solar cell.

According to an embodiment of the invention, the substrate includes a rigid substrate or a flexible substrate.

According to an embodiment of the invention, the active layer entirely covers the substrate.

According to an embodiment of the invention, the active layer has a continuous pattern to extend from the touch sensing region to the non-touch sensing region.

According to an embodiment of the invention, a projection area of the active layer on the substrate is substantially equal to a total area of the touch sensing region and the non-touch sensing region.

According to an embodiment of the invention, a material of the active layer includes an organic material and an inorganic semiconductor material.

According to an embodiment of the invention, the first bottom electrode and the first top electrode apply a bias to the portion of the active layer located in the touch sensing region.

According to an embodiment of the invention, the bias is a reverse bias.

According to an embodiment of the invention, the touch sensing device further includes a power storage device electrically connected to the solar cell. For instance, the power storage device includes a battery.

According to an embodiment of the invention, the touch sensing device further includes a touch sensing signal processor that is electrically connected to the optical touch sensing unit.

As described in the embodiments of the invention, since the optical touch sensing unit and the solar cell in the touch sensing device share the same active layer, the fabrication of the optical touch sensing unit is integrated with the fabrication of the solar cell. Thereby, the manufacturing costs of the touch sensing device can be reduced, and the light-receiving area of the solar cell can also be expanded.

To make the above and other features and advantages of the invention more comprehensible, several embodiments accompanied with figures are detailed as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view illustrating a touch sensing device according to an embodiment of the invention.

FIG. 2 is a schematic top view illustrating a touch sensing device according to another embodiment of the invention.

FIG. 3A to FIG. 3C are schematic cross-sectional views respectively taken along section lines A-A′, B-B′, and C-C′ depicted in FIG. 2.

### DESCRIPTION OF EMBODIMENTS

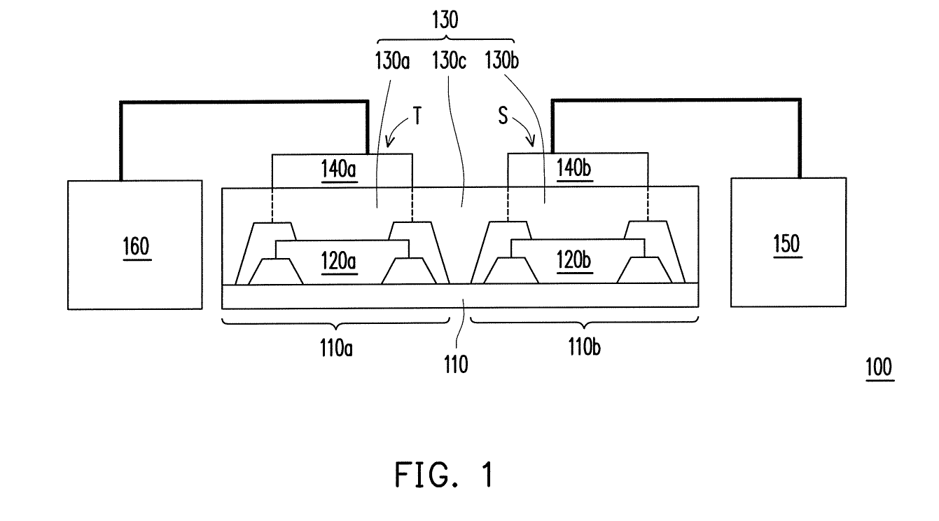

FIG. 1 is a schematic cross-sectional view illustrating a touch sensing device according to an embodiment of the invention. With reference to FIG. 1, the touch sensing device 100 of this embodiment includes a substrate 110, at least one first bottom electrode 120a, at least one second bottom electrode 120b, an active layer 130, at least one first top electrode 140a, and at least one second top electrode 140b. The substrate 110 has a touch sensing region 110a where the first bottom electrode 120a is located and a non-touch sensing region 110b where the second bottom electrode 120b is located. The first and second bottom electrodes 120a and 120b are electrically insulated from each other. The active layer 130 is located on the substrate 110 and extends from the touch sensing region 110a to the non-touch sensing region 110b. The first top electrode 140a is located on the active layer 130 and above the first bottom electrode 120a. The second top electrode 140b is located on the active layer 130 and above the second bottom electrode 120b. A first portion of the active layer 130 located in the touch sensing region 110a, the first top electrode 140a, and the first bottom electrode 120a constitute an optical touch sensing unit T. A second portion of the active layer 130 located in the non-touch sensing region 110b, the second top electrode 140b, and the second bottom electrode 120b constitute a solar cell S.

In this embodiment, the active layer 130 has a continuous pattern to extend from the touch sensing region 110a to the non-touch sensing region 110b. Specifically, the active layer 130 includes a region 130a, a region 130b, and a region 130c. The region 130a of the active layer 130 is sandwiched by the first bottom electrode 120a and the first top electrode 140a, and the region 130b of the active layer 130 is sandwiched by the second bottom electrode 120b and the second top electrode 140b. The region 130c of the active layer 130 is not covered by any electrode and is connected between the regions 130a and 130b. In other words, the region 130a of the active layer 130 is defined by the first bottom electrode 120a and the first top electrode 140a; the region 130b of the active layer 130 is defined by the second bottom electrode 120b and the second top electrode 140b; the region 130c of the active layer 130 is defined by the first bottom electrode 120a, the first top electrode 140a, the second bottom electrode 120b, and the second top electrode 140b.

In order to effectively store the electric power generated by the solar cell S in the touch sensing device 100, the touch sensing device 100 described in this embodiment may further include a power storage device 150 that is electrically connected to the solar cell S. Here, the power storage device 150 is a battery, for instance. Particularly, the power storage device 150 is electrically connected to the solar cell S through the bus line.

To process the touch sensing signal generated by the optical touch sensing unit T in the touch sensing device 100, the touch sensing device 100 described in this embodiment may further include a touch sensing signal processor 160 that is electrically connected to the optical touch sensing unit T. Specifically, the touch sensing signal processor 160 is electrically connected to the optical touch sensing unit T through the readout line.

In this embodiment, the configuration and the location of the optical touch sensing unit T (i.e., the configuration and the location of the touch sensing region 110a) are defined by the configurations and the locations of the first bottom electrode 120a and the first top electrode 140a, and the configuration and the location of the solar cell S (i.e., the configuration and the location of the non-touch sensing region 110b) are defined by the configurations and the locations of the second bottom electrode 120b and the second top electrode 140b. The configurations and the locations of the touch sensing region 110a and the non-touch sensing region 110b may be properly modified based on design requirements, which should not be construed as a limitation to this embodiment.

The touch sensing device 100 described in this embodiment can be applied to a touch sensing keyboard (e.g., a keyboard assembled to a notebook computer or a keyboard connected to a personal computer through a specific interface), a keypad of a mobile phone, keys of computers, a mouse, and other electronic products. Based on different applications of the touch sensing device 100, the substrate 110 of this embodiment may be a rigid substrate or a flexible substrate. Besides, the substrate 110 of this embodiment is not required to have a flat and smooth surface. Namely, the surface of the substrate 110 for holding the first bottom electrode 120a, the second bottom electrode 120b, the active layer 130, the first top electrode 140a, and the second top electrode 140b can be a curved surface or a surface with a certain profile.

For instance, in an exemplary touch sensing keyboard, people having ordinary skill in the art can determine the number of the optical touch sensing units T based on the number of keys required by the touch sensing keyboard. The configuration and the location of each of the optical touch sensing units T are determined by one first bottom electrode 120a and one first top electrode 140a, and the number of the optical touch sensing units T is equal to the number of keys required by the touch sensing keyboard. Note that the number of the optical touch sensing units T is irrelevant to the active layer 130 but is relevant to the number of the first bottom electrode 120a and the number of the first top electrode 140a.

As clearly shown in FIG. 1, the active layer 130 entirely covers the substrate 110, for instance, so as to cover the first bottom electrode 120a and the second bottom electrode 120b on the substrate 110. That is to say, the area of the active layer 130 is substantially equal to the area of the substrate 110, i.e., the projection area of the active layer 130 on the substrate 110 is substantially equal to the total area of the touch sensing region 110a and the non-touch sensing region 110b. However, the invention is not limited thereto. In other embodiments of the invention, the area of the active layer 130 is slightly smaller than the area of the substrate 110, for instance. That is to say, the outer edge of the active layer 130 is not aligned to the outer edge of the substrate 110, and there can be a proper distance between the outer edge of the active layer 130 and the outer edge of the substrate 110.

To normally operate the optical touch sensing unit T, a bias is applied to the optical touch sensing unit T in this embodiment. Additionally, the solar cell S applies another bias to the power storage device 150, such that the electric power generated by the solar cell S after light irradiation can be stored in the power storage device 150. In this embodiment, the first bottom electrode 120a and the first top electrode 140a can apply a bias V1 to a first portion of the active layer 130 (i.e., the region 130a) in the touch sensing region 110a, such that the optical touch sensing unit T can be normally operated. Due to the transmission via the second bottom electrode 120b and the second top electrode 140b, the electric power generated by the solar cell S after light irradiation can be stored in the power storage device 150, and the solar cells S located on the non-touch sensing region 110b can, by way of serial connection or parallel connection, provide the voltage and current required by the power storage device 150. For instance, the bias V1 applied to the region 130a ranges from −0.1 V to −10 V, for instance, and the bias V2 provided by the solar cell S to the power storage device 150 ranges from 0.5 V to 20 V, for instance.

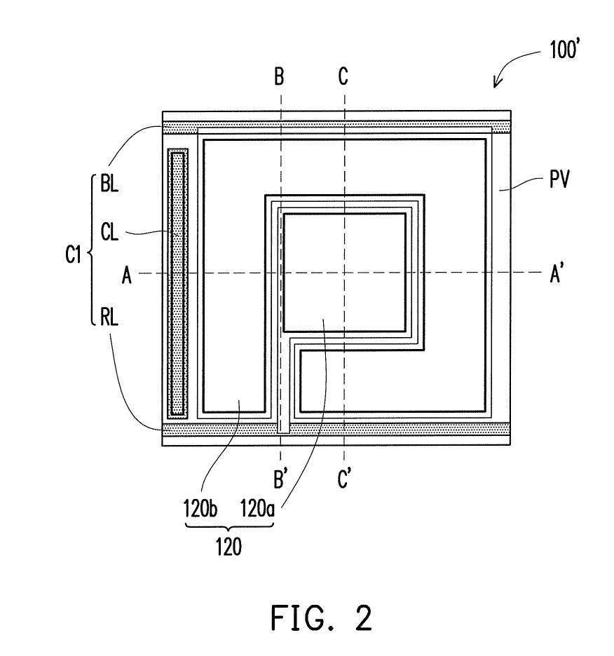

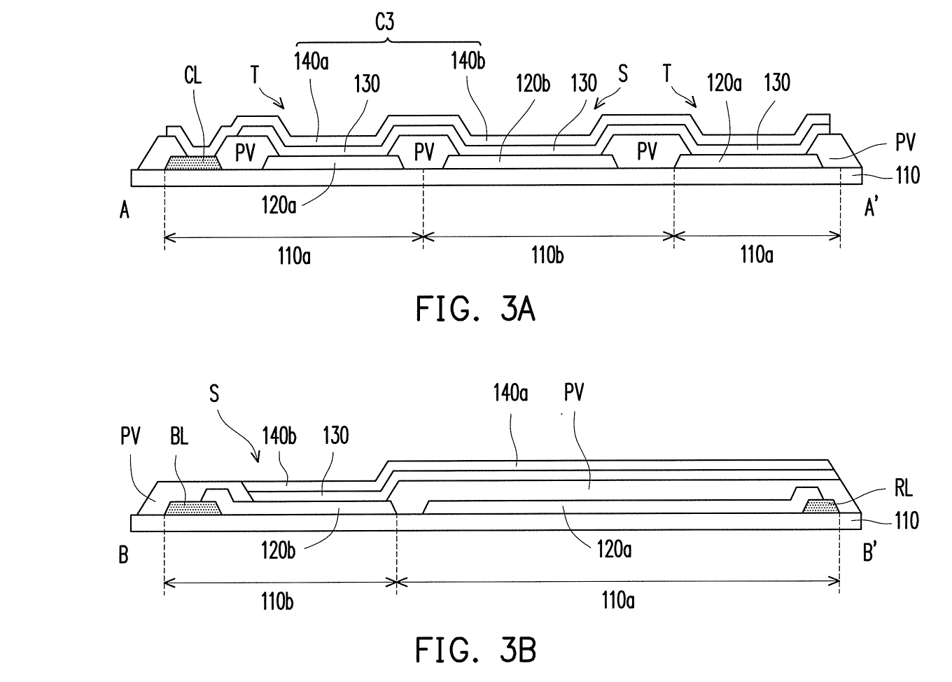

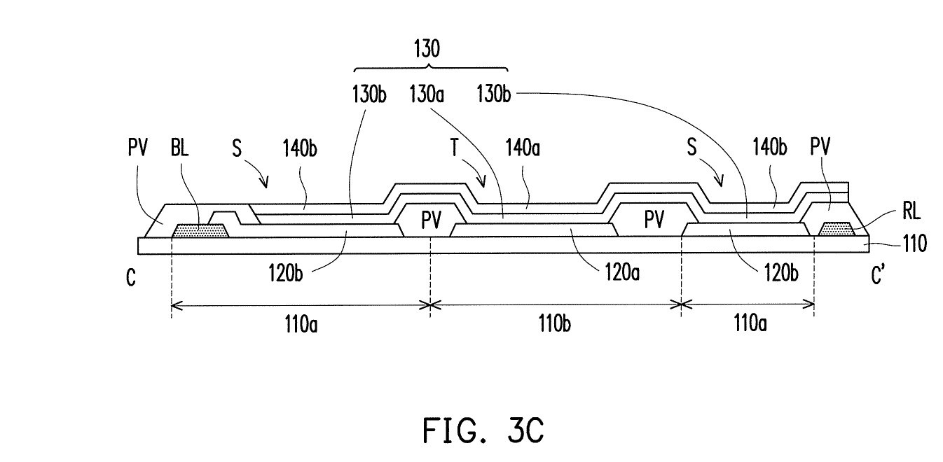

FIG. 2 is a schematic top view illustrating a touch sensing device according to an embodiment of the invention. FIG. 3A to FIG. 3C are schematic cross-sectional views respectively taken along section lines A-A′, B-B′, and C-C′ depicted in FIG. 2. With reference to FIG. 2 and FIG. 3A to FIG. 3C, the touch sensing device 100′ of this embodiment is similar to the aforesaid touch sensing device 100, while the main difference rests in the layout. The touch sensing device 100′ is elaborated hereinafter.

As indicated in FIG. 2 and FIG. 3A to FIG. 3C, the touch sensing device 100′ of this embodiment includes a substrate 110, a first patterned conductive layer C1, a second patterned conductive layer C2, a patterned protection layer PV, an active layer 130, and a third patterned conductive layer C3. The first patterned conductive layer C1 includes a readout line RL that is configured on the substrate 110, a contact line CL that is configured on the substrate 110, and a bus line BL that is configured on the substrate 110. The second patterned conductive layer C2 includes a first bottom electrode 120a and a second bottom electrode 120b that are electrically insulated from each other. The third patterned conductive layer C3 includes a first top electrode 140a and a second top electrode 140b.

It can be learned from FIG. 3A to FIG. 3C that the patterned protection layer PV covers the readout line RL, the bus line BL, and a portion of the substrate 110, while the patterned protection layer PV exposes the contact line CL, the first bottom electrode 120a, and the second bottom electrode 120b. Besides, the edge of the contact line CL, the edge of the bus line BL, the edge of the first bottom electrode 120a, and the edge of the second bottom electrode 120b can be covered by the patterned protection layer PV. In this embodiment, the patterned protection layer PV is made of a dielectric material or an insulation material, for instance.

The active layer 130 covers the first bottom electrode 120a, the second bottom electrode 120b, and the patterned protection layer PV, and the active layer 130 extends from the top of the first bottom electrode 120a to the top of the second bottom electrode 120b. The first top electrode 140a and the second top electrode 140b cover the active layer 130 and are electrically connected to each other, for instance. Namely, the third patterned conductive layer C3 has a continuous pattern. The third patterned conductive layer C3 located above the first bottom electrode 120a is defined as the first top electrode 140a, and the third conductive layer C3 located above the second bottom electrode 120b is defined as the second top electrode 140b.

The third patterned conductive layer C3 extends to the contact line CL and is electrically connected to the contact line CL. In addition, the patterned protection layer PV can effectively avoid the third patterned conductive layer C3 from being electrically connected to the readout line RL and the bus line BL. Hence, the optical touch sensing unit T and the solar cell S can be individually and normally operated.

According to this embodiment, the active layer 130 is made of an inorganic photo-voltaic conversion material or an organic photo-voltaic conversion material, for instance. Here, the inorganic photo-voltaic conversion material is amorphous silicon (a-Si), micro-silicon (μc-Si), or cadmium arsenide (CdTe), for instance, and the thickness of the inorganic photo-voltaic conversion material ranges from 0.1 μm to 2 μm, for instance. In other feasible embodiments of the invention, the inorganic photo-voltaic conversion material is copper indium gallium selenide (CIGS), copper indium selenide (CIS), copper gallium selenide (CGS), copper gallium telluride (CGT), copper indium aluminum selenide (CIAS), the group II-VI semiconductor, or the group III-V semiconductor, for instance, and the thickness of the inorganic photo-voltaic conversion material ranges from 1 μm to 3 μm, for instance.

The organic photo-voltaic conversion material is poly(3-hexylthiophene):[6,6]-phenyl-C61-butyric acid methyl ester, P3HT [60]PCBM, poly[2-methoxy-5-(30,70-dimethyloctyloxy)-1,4-phenylenevinylene]: [6,6]-phenyl-C61-butyricacidmethyl ester, MDMO-PPV:[60]PCBM, poly[2,6-(4,4-bis-(2-ethylhexyl)-4H-cyclopenta[2,1-b; 3,4-b′]dithiophene)-alt-4,7-(2,1,3-benzothiadiazole)]: [6,6]-phenyl-C71 butyric acid methyl ester, PCPDTBT:[70]PCBM, or poly[4,8-bis-substituted-benzo[1,2-b:4,5-b′] dithiophene-2,6-diyl-alt-4-substituted-thieno[3,4-b]thio-phene-2,6-diyl]:[6,6]-phenyl-C71 butyric acid methyl ester, PBDTTT:[70]PCBM, for instance. Besides, the thickness of the organic photo-voltaic conversion material ranges from 50 μm to 300 μm, for instance.

As described in the embodiments of the invention, since the optical touch sensing unit and the solar cell in the touch sensing device share the same active layer, the fabrication of the optical touch sensing unit is integrated with the fabrication of the solar cell. Thereby, the manufacturing costs of the touch sensing device can be reduced, and the light-receiving area of the solar cell can also be expanded.

Although the invention has been disclosed by the above embodiments, they are not intended to limit the invention. Those skilled in the art may make some modifications and alterations without departing from the spirit and scope of the invention. Therefore, the protection range of the invention falls in the appended claims.

What is claimed is:

1. A touch sensing device, comprising:
a substrate having a touch sensing region and a non-touch sensing region;
a first bottom electrode located on the touch sensing region;
a second bottom electrode located on the non-touch sensing region, wherein the first bottom electrode and the second bottom electrode are electrically insulated from each other;
an active layer located on the substrate and extending from the touch sensing region to the non-touch sensing region;
a first top electrode located on the active layer and above the first bottom electrode; and
a second top electrode located on the active layer and above the second bottom electrode, wherein a first portion of the active layer located in the touch sensing region, the first bottom electrode, and the first top electrode constitute an optical touch sensing unit, and a second portion of the active layer located in the non-touch sensing region, the second bottom electrode, and the second top electrode constitute a solar cell.

2. The touch sensing device as recited in claim 1, wherein the substrate comprises a rigid substrate or a flexible substrate.

3. The touch sensing device as recited in claim 1, wherein the active layer entirely covers the substrate.

4. The touch sensing device as recited in claim 1, wherein the active layer has a continuous pattern to extend from the touch sensing region to the non-touch sensing region.

5. The touch sensing device as recited in claim 1, wherein a projection area of the active layer on the substrate is substantially equal to a total area of the touch sensing region and the non-touch sensing region.

6. The touch sensing device as recited in claim 1, wherein a material of the active layer comprises an organic material and an inorganic material.

7. The touch sensing device as recited in claim 1, wherein the first bottom electrode and the first top electrode apply a bias to the first portion of the active layer located in the touch sensing region.

8. The touch sensing device as recited in claim 7, wherein the bias is a reverse bias.

9. The touch sensing device as recited in claim 1, further comprising a power storage device electrically connected to the solar cell.

10. The touch sensing device as recited in claim 9, wherein the power storage device comprises a battery.

11. The touch sensing device as recited in claim 1, further comprising a touch sensing signal processor electrically connected to the optical touch sensing unit.
